(19) United States
(12) Patent Application Publication
(10) Pub. No.: US 2003/0040245 A1
(43) Pub. Date: Feb. 27, 2003

(54) Method for manufacturing additive soft mold for forming barrier ribs of PDP and method for forming barrier ribs

(76) Inventors: Bok Sik Song, Seoul (KR); Keon Hwan Kim, Seoul (KR); Kwang Ho Lee, Seoul (KR); Jeong Woong Choi, Gyeonggi-Do (KR); Lee Soon Park, Daegu (KR); Seung Won Jeong, Daegu (KR); Sin Hye Paek, Busan (KR); Sang Won Yun, Daegu (KR); Kyoung Seok Shin, Gyeonggi-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/222,661

(22) Filed: Aug. 16, 2002

(30) Foreign Application Priority Data
Aug. 24, 2001 (KR) 2001-51457

(51) Int. Cl. H01J 9/24

(52) U.S. Cl. 445/24

(57) ABSTRACT

Provided is a plasma display panel (PDP) manufacturing technology, and more particularly, to a method for manufacturing an additive soft mold forming barrier ribs of a PDP and a method for forming barrier ribs of a PDP that can prevent camber and damage of a glass substrate, produce barrier ribs with uniform height, and make the soft mold separated easily. In this research, an additive soft mold is manufactured using an elastic rubber material, and barrier ribs of a PDP are formed by using the additive soft mold. In particular, the barrier rib paste can be filled by polishing the rear surface of the soft mold and forming an opening, using a squeezer instead of performing a pressing process. When a photopolymerizing photosensitive paste is used as a paste for forming barrier ribs, and it is exposed to UV light, the soft mold can be separated easily from the paste, because the polymer in the paste shrinks due to the polymerization reaction.

### FIELD OF THE INVENTION

The present invention relates to a plasma display panel (PDP) manufacturing technology, and more particularly, to a method for manufacturing an additive soft mold forming barrier ribs of a PDP and a method for forming barrier ribs of a PDP.

### DESCRIPTION OF RELATED ART

A plasma display panel (PDP) is a device for displaying a picture using plasma generated by discharge gases. It is known as a gas discharge display device. In the PDP, discharge gases, such as Ne and Xe, are supplied into a space between the upper and lower plates, and an ultraviolet ray generated from the discharge gases excites red (R), green (G) and blue (B) fluorescents and produce visible light.

The PDP is divided into two types: a direct current (DC) type and an alternating current (AC) type. The AC type PDP can be classified again into an opposite discharge type and a surface discharge type. The opposite discharge type has the disadvantage that the life span is shortened by the degradation of the fluorescent substances owing to the ion impact. In the surface discharge type, on the other hand, the discharge is collected in a panel opposite to the fluorescent substances in order to minimize the degradation of the fluorescent substances and thus overcome the shortcoming of the opposite discharge type. Nowadays, most PDPs adopt the surface discharged type.

Referring to FIG. 1, which is a cross-sectional view illustrating a surface-discharged AC type of PDP, the surfaced-charged AC type PDP comprises a rear plate and a front plate. The rear plate is formed of a rear glass substrate 10, an address electrode 11, a white dielectric 12, and barrier ribs 13. The front plate is formed of a front glass substrate 14, transparent electrode 15, bus electrodes 16, transparent dielectric 17, a dielectric protection layer 18, black stripes (not shown). The fluorescents (R, G, B) 19 for embodying colors in the PDP are placed on the front plate in case of a transparent type. In case of a reflective type, they are placed between the barrier ribs 13 of the rear plate, as illustrated in the drawing.

It is difficult to form the barrier ribs, because the barrier ribs are formed in three-dimensional structure between the barrier ribs with a linewidth around 50˜80 μm. Methods for forming barrier ribs of a PDP include screen printing, sandblasting, photolithography, low temperature co-fired ceramic on metal (LTCC-M), and press methods.

In the screen printing method, the process of printing and drying is repeated several times utilizing a screen mask to obtain a desired pattern. Since this process should be performed repeatedly until the desired height is obtained, there are problems, such as slanting barrier ribs, unstable discharge resulting from the high deviation of the barrier ribs height, dropping uniformity in the formation of fluorescent substances, screen mask mesh marks. Accordingly, throughput is decreased due to the low reproducibility of the screen printing method. Also, the limitation of the screen mask makes it hard to form fine and clean pattern.

In the sandblasting method, barrier ribs are formed through the process of coating a barrier rib paste to a thickness of 300˜400 μm and drying it, laminating a sanding-resistant dry film resist (DFR) to it, performing patterning through light exposure and development, and sandblasting the barrier rib material with fine abrasive granules by using the pattern as a mask. The sandblasting method is advantageous in that it can form fine and clean barrier ribs, compared to the press method, but it has disadvantages that the process is complicated and has high material loss. In addition, it is difficult to separate powder mixture generated in the sandblasting, and since the powder mixture is a polluting material, the sandblasting method is not environment-friendly. Moreover, it is disadvantageous because the barrier ribs are cracked during the subsequent plasticity process due to strong physical impact applied to the glass substrates in the sandblasting process.

To form the barrier ribs in the photolithographic method, a photosensitive barrier rib paste is coated, dried, and exposed to light through a photo mask. Then, the paste of the unexposed areas is dissolved selectively in development solution and removed. The photolithographic method is advantageous because the dimensions of barrier ribs can be controlled precisely. However, the method has disadvantages that the paste loss rate is high and barrier ribs over 100 μm can hardly be formed, because the lower portion of the photosensitive barrier rib paste cannot be exposed to light.

FIGS. 2A through 2C are cross-sectional views showing the conventional process for forming barrier ribs using a press method. To form barrier ribs in the conventional press method, first, a non-photosensitive barrier rib dry film tape 21 is laminated on the glass substrate 20, and a metal mold engraved with a barrier rib pattern is aligned over the barrier rib dry film 21, as shown in FIG. 2A. Then, as depicted in FIG. 2B, the mold is pressed on the glass substrate 20. Subsequently, as shown in FIG. 2C, the metal mold plate is separated in the vertical direction and thereby the barrier ribs 21a is formed.

The conventional press method, which is described above, is advantageous in that the process is very simple and the material is hardly wasted, but it has disadvantages that the height of the barrier ribs 21a is not uniform, and the glass substrate 20 may be damaged by the pressure applied by the metal mold plate. In addition, it is hard to detach the barrier rib dry film 21 from the metal mold plate 22 after the pressing process.

In the LTCC-M method, the rear glass substrate is formed by laminating dielectric dry film on a metal substrate, which is made of, for example, Ti, forming address electrodes on the dielectric layer, putting barrier rib dry film, forming barrier ribs by pressing the metal substrate with an embossing mold, which is a mold plate made of metal, and performing simultaneous plasticity process on the entire substrate. The LTCC-M method is advantageous in that the process is simple and saves the cost for material and equipment. However, in order to use the LTCC-M method in the practical mass-production of PDPs, some technical problems should be solved. That is, the pattern should be separated easily after the pressing process, and the substrates should be protected from camber during the plasticity and the pressing processes.

### SUMMARY OF THE INVENTION

It is, therefore, an object of the present invention to provide a method for manufacturing an additive soft mold for forming barrier ribs of a plasma display panel (PDP) and a method for forming barrier ribs of a PDP using the additive soft mold, which can prevents camber or damage of a substrate, secures the uniformity of barrier ribs, and has a soft mold separated easily after pressing.

In accordance with an aspect of the present invention, there is provided a method for manufacturing an additive soft mold for forming barrier ribs of a plasma display panel, comprising: coating a photoresist on a substrate for a basic mold frame; forming a basic mold frame by forming a photoresist pattern using a photomask with a barrier rib pattern drawn thereon; pouring a liquid-phase rubber material to the basic mold frame; hardening the rubber material; separating the hardened rubber material from the basic mold frame; and forming an opening by polishing the rear surface of the hardened rubber material, wherein the opening defines regions of barrier ribs.

In accordance with another aspect of the present invention, there is provided a method for forming barrier ribs of a plasma display panel, comprising: providing an additive soft mold having openings for barrier ribs; aligning the additive soft mold on a substrate; filling the barrier rib paste through the opening of the additive soft mold, wherein the paste is a photopolymerizing photosensitive paste; inducing a polymerization reaction by exposing the paste to UV light; separating the additive soft mold; and performing plasticity process on the remaining of the barrier rib layer.

This invention manufactures an additive soft mold using an elastic silicone rubber to form barrier ribs using the additive soft mold. In particular, barrier ribs can be formed using a squeezer without performing a pressing process by polishing the rear surface of the soft mold to form an opening. Meanwhile, when a photopolymerizing photosensitive paste is used and a UV light exposure is performed after the paste filling process, the polymer in the paste shrink due to polymerization and thus the separation of the mold becomes easy.

### BRIEF DESCRIPTION OF THE DRAWING(S)

The above and other objects and features of the present invention will become apparent from the following description of the preferred embodiments given in conjunction with the accompanying drawings, in which:

FIG. 1 is a cross-sectional view illustrating a surfaced-discharged AC type plasma display panel (PDP);

FIGS. 2A through 2C are cross-sectional views showing the conventional process for forming barrier ribs using a press method;

FIGS. 3A through 3F are diagrams showing the process for manufacturing an additive soft mold in accordance with a preferred embodiment of the present invention;

FIG. 4 is a plane figure of an additive soft mold manufactured in accordance with the embodiment of the present invention; and

FIGS. 5A through 5D represent diagrams showing a method for forming barrier ribs of a PDP by using the additive soft mold in accordance with an embodiment of the present invention.

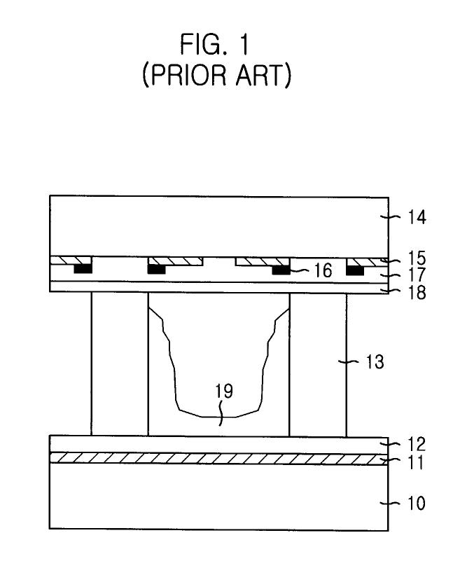

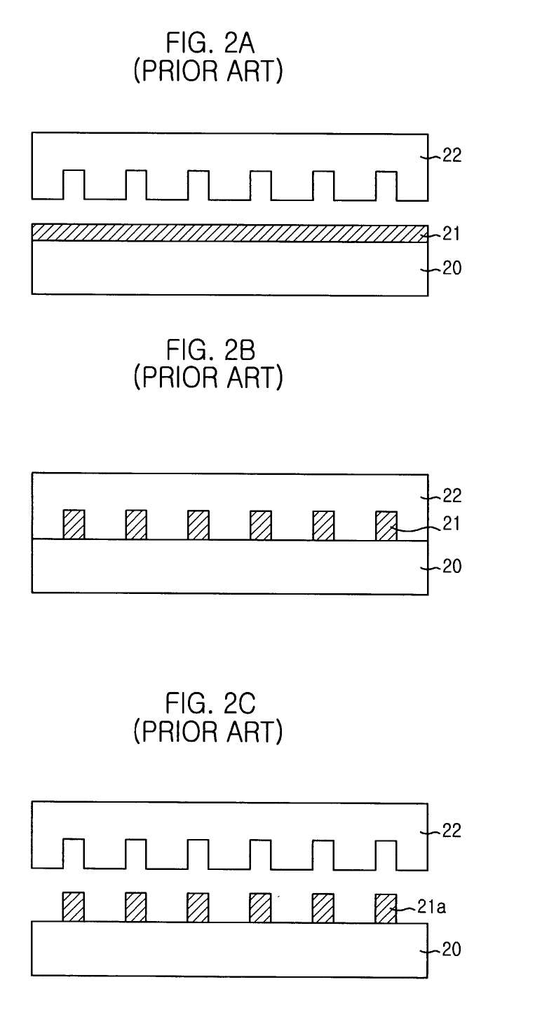

### DETAILED DESCRIPTION OF THE INVENTION

Other objects and aspects of the invention will become apparent from the following description of the embodiments with reference to the accompanying drawings.

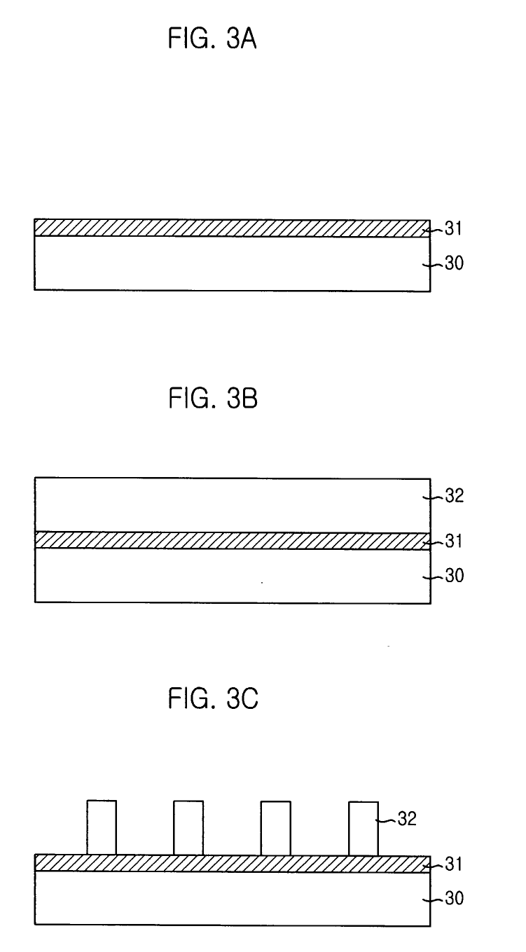

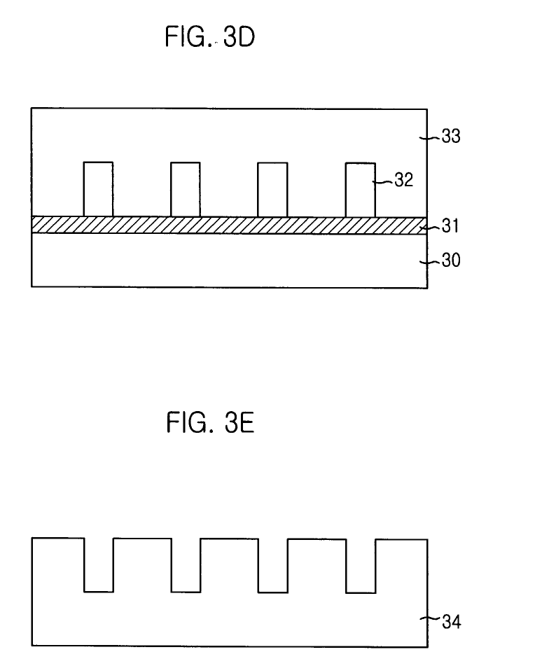

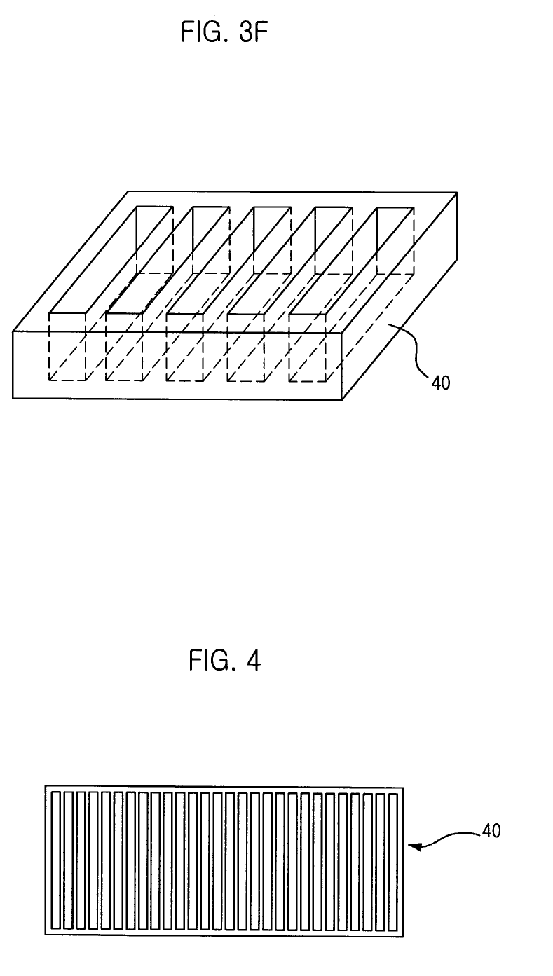

FIGS. 3A through 3F are cross-sectional views showing the process for manufacturing an additive soft mold in accordance with an embodiment of the present invention. Referring to FIG. 3A, a silicone coupling agent 31, e.g., Z-6040 of Dow Corning Company, is coated in a thickness of 0.1˜0.2 μm on the surface of a glass substrate 30. Subsequently, as shown in FIG. 3B, a negative photoresist 32, e.g., SU8 of Microchem Company, is coated to form a thick layer and dried at 90° C. for 20 minutes. Then, referring to FIG. 3C, a basic mold frame is manufactured by performing light exposure through a photomask with a barrier rib pattern drawn thereon and carrying out development. Here, the wavelength of the light source is 360˜420 nm, and the energy of the light exposure is 600˜1000 mJ/cm².

Subsequently, referring to FIG. 3D, a liquid-phase transparent silicone rubber material 33 that is hardened in the room temperature, for example, a mixture of silicone resin and hardening agent mixed in the ratio of 5˜15:1, or liquid urethane rubber material is poured to a basic mold frame, and hardened in an oven at about 40° C. for around an hour, after air is removed. Then, referring to FIG. 3E, a soft mold frame 34 is obtained by separating the hardened transparent silicone rubber 34 from the base mold frame. Referring to FIG. 3F, an additive soft mold is obtained by polishing the rear surface of the soft mold frame 34. Here, the polishing is performed until the barrier rib pattern is exposed to form an opening.

FIG. 4 is a plane figure of a soft mold manufactured through the above described process, in which the reference numeral ‘40’ denotes an additive soft mold. In the present invention, the additive soft mod for forming barrier ribs of a PDP is manufactured of an elastic material, such as silicone rubber. In this method, various cell structure, i.e., barrier rib structure can be embodied by altering the design of a photomask.

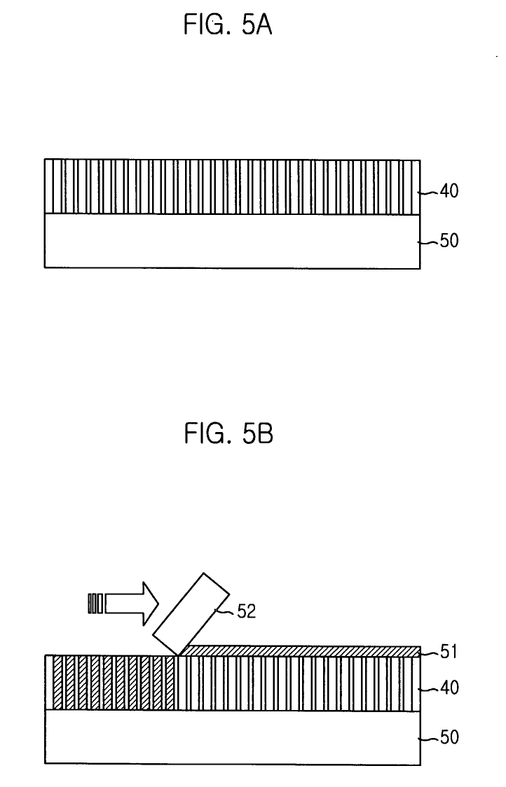

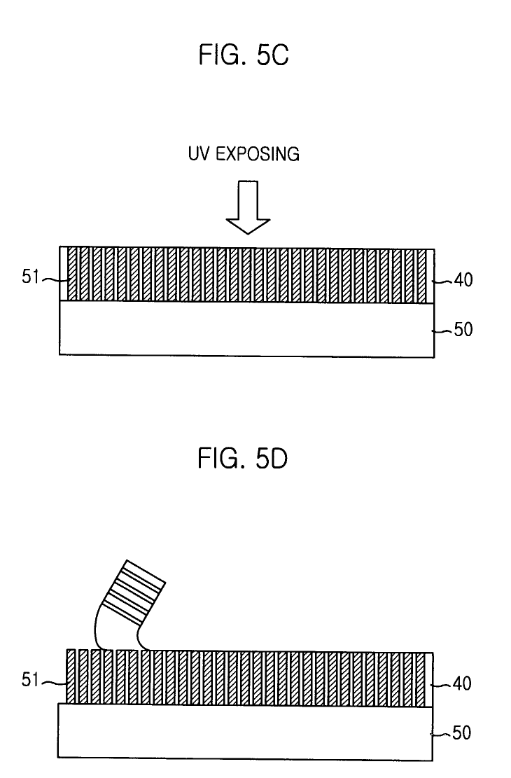

FIGS. 5A through 5D represents a method for forming barrier ribs of a PDP by using the additive soft mold in accordance with an embodiment of the present invention. First, referring to FIG. 5A, the soft mold 40 is aligned on the rear substrate of PDP 50 which has gone through a predetermined process. Then, referring to FIG. 5B, a photopolymerizing photosensitive barrier rib paste 51 is coated on the additive soft mold 40, and filled into the groove of the additive soft mold 40 in a thickness of 200˜300 μm by using a squeezer 52. Subsequently, the photopolymerizing photosensitive barrier rib paste 51 is exposed to UV light, as illustrated in FIG. 5C.

Referring to FIG. 5D, when the interface adhesiveness between the additive soft mold 40 and the photopolymerizing photosensitive barrier rib paste 51 is decreased by the UV light exposure, the elastic additive soft mold 40 is separated gradually from the edge of one end towards the center as if it were rolled up, and plasticity process is performed at 550˜580° C. to burn out all organic materials in the photopolymerizing photosensitive barrier rib paste 51. With inorganic barrier rib materials left, barrier ribs with the height of 110˜200 μm can be obtained.

The above described process is simple, and since it uses a method of filling, instead of pressing, the glass surface is not damaged. Also, in this process, the mold can be separated easily, because the polymer in the paste shrinks by the polymerization during the UV light exposure and the interfacial adhesion is reduced. Since the elastic soft mold can be separated as if it were rolled up, after the UV light exposure, the contact area of the additive soft mold and the barrier rib paste becomes small and this makes it easy to separate the soft mold. Meanwhile, the height of barrier ribs formed in the conventional press method has a deviation of 10% from the average height, that of the barrier ribs obtained in the method of the present invention shows a deviation of less than 1%.

As described above, the present invention increases the throughput by preventing camber and damage of a glass substrate, minimizes potential damage of barrier ribs that may be caused during the separation of the mold, and produces PDPs with fine and clean barrier ribs of uniform height. In addition, it is possible to form various barrier rib patterns by using a negative photoresist, which is used for forming a thick layer, in manufacturing a basic mold frame.

While the present invention has been described with respect to certain preferred embodiments, it will be apparent to those skilled in the art that various changes and modifications may be made without departing from the scope of the invention as defined in the following claims.

What is claimed is:

1. A method for manufacturing an additive soft mold for forming barrier ribs of a plasma display panel, comprising:
coating a photoresist on a substrate for a basic mold frame;
forming a basic mold frame by forming a photoresist pattern using a photomask with a barrier rib pattern drawn thereon;
pouring a liquid-phase rubber material to the basic mold frame;
hardening the rubber material;
separating the hardened rubber material from the basic mold frame; and
forming an opening by polishing the rear surface of the hardened rubber material, wherein the opening defines regions of barrier ribs.

2. The method as recited in claim 1, further comprising a step of coating silicone coupling agent on the surface of the glass substrate for the basic frame mold to form an adhesive layer.

3. The method as recited in claim 1, wherein the rubber material is a liquid-phase silicone material that is hardened in the room temperature.

4. The method as recited in claim 1, wherein the rubber material is a liquid-phase urethane rubber material.

5. A method for forming barrier ribs of a plasma display panel, comprising:
providing an additive soft mold having openings for barrier ribs;
aligning the additive soft mold on a substrate;
filling the barrier rib paste through the opening of the additive soft mold, wherein the paste is a photopolymerizing photosensitive paste;
inducing a polymerization reaction by exposing the paste to UV light;
separating the additive soft mold; and
performing plasticity process on the remaining of the barrier rib layer.

6. The method as recited in claim 5, wherein the step of filling the paste for the barrier rib layer comprises the steps of:
coating the paste on the additive mold; and
filling the paste into the opening using a squeezer.
